(19) United States
(12) Patent Application Publication
(10) Pub. No.: US 2015/0356064 A1
(43) Pub. Date: Dec. 10, 2015

(54) MANAGEMENT SYSTEM FOR DISPLAYING INFORMATION RELATING TO TARGET

(71) Applicant: HITACHI, LTD., Chiyoda-ku, Tokyo (JP)

(72) Inventors: TOMOKI MIZUNO, Tokyo (JP); Sayuri KIUCHI, Tokyo (JP)

(73) Assignee: Hitachi, Ltd., Tokyo (JP)

(21) Appl. No.: 14/759,043

(22) PCT Filed: Sep. 24, 2013
(86) PCT No.: PCT/JP2013/075709

§ 371 Date: Jul. 2, 2015

(51) Int. Cl. G06F 17/24; G06F 3/0484; G06T 11/20; G06F 3/0482

(52) U.S. Cl. CPC G06F 17/241; G06F 3/0482; G06F 3/04842; G06T 11/206

(57) ABSTRACT

A management system, on the basis of a value group that includes a plurality of values included in time-series data relating to a target, corresponding to a first standpoint, and corresponding respectively to a plurality of time points, displays a graph that has a first axis corresponding to a time and a second axis corresponding to the first standpoint and represents time-series variation of values corresponding to the first standpoint, and displays electronic tags at designated coordinates that are coordinates designated by a user, in the graph. The management system displays characters that are input by a user, in a displayed electronic tag. The management system stores, in a storage device, a tag information unit with which designated coordinates (values and time point) and characters input in an electronic tag are associated. In the graph that is re-displayed by the management system, provided is the electronic tag at coordinates including values and time point associated with the tag information unit.

### TECHNICAL FIELD

The present invention generally relates to display of information relating to a target.

### BACKGROUND ART

Regarding information display, for example, a technique disclosed in PTL 1 is known. According to PTL 1, a document preparation support apparatus displays comments on a graph including a time axis.

### CITATION LIST

### Patent Literature [PTL 1] Japanese Unexamined Patent Application Publication No. 2007-41728

### SUMMARY OF INVENTION

### Technical Problem

According to PTL 1, comments are simply displayed on a graph, and the nature of a graph, on the display of information such as comments, is not in consideration.

### Solution to Problem

A management system, on the basis of a value group that includes a plurality of values included in time-series data relating to a target, corresponding to a first standpoint, and corresponding respectively to a plurality of time points, displays a graph that has a first axis corresponding to a time and a second axis corresponding to the first standpoint and represents time-series variation of values corresponding to the first standpoint, and displays electronic tags at designated coordinates that are coordinates designated by a user, in the graph. The management system displays characters that are input by a user, in a displayed electronic tag. The management system stores, in a storage device, a tag information unit with which designated coordinates (values and time point) and characters input in an electronic tag are associated. In the graph that is re-displayed by the management system, provided is the electronic tag at coordinates including values and time point associated with the tag information unit.

### Advantageous Effects of Invention

When an electronic tag is displayed (e.g., pasted) on a graph, a correspondence relation between the display location (designated coordinates) of the electronic tag and the characters input in the electronic tag is stored. When the graph is re-displayed, the electronic tag is displayed at the display location. Thereby the electronic tag display is achieved, utilizing the nature of graphs that is to grasp a relationship between time points and values.

### BRIEF DESCRIPTION OF DRAWINGS

FIG. 1 shows a configuration of a computer system according to an embodiment.

FIG. 2 shows a configuration of a management server and a computer for display respectively.

FIG. 3 shows a metric definition table.

FIG. 4 shows a memo management table.

FIG. 5 shows an axis set management table.

FIG. 6 shows a metric management table.

FIG. 7 shows an example of a graph screen.

FIG. 8 shows an example of a screen when a memo is pasted.

FIG. 9 shows a method of selecting an axis set.

FIG. 10 shows an example of an axis set configuring screen.

FIG. 11 shows an example of a memo list screen.

FIG. 12 shows a flow of a memo pasting process.

FIG. 13 shows a flow of a memo moving process.

FIG. 14 shows a flow of a memo deleting process.

FIG. 15 shows a flow of a memo editing process.

FIG. 16 shows a flow of an axis set configuring process flow.

FIG. 17 shows a flow of an axis set selecting process.

FIG. 18 shows a flow of a graph screen display process.

FIG. 19 shows a flow of a graph drawing process.

FIG. 20 shows a flow of a memo list screen display process.

FIG. 21 shows a flow of a memo list pop⁻up process.

FIG. 22 shows a flow of a graph activation process.

### DESCRIPTION OF EMBODIMENTS

Hereinafter, an embodiment will be explained.

In the explanation below, information is occasionally explained with an expression “xxx table”; however, information may be expressed by any data structure. Namely, in order to show that information does not rely on a data structure, “xxx table” may be mentioned as “xxx information.”

Also, in the following explanation, a process may be explained with “program” as the subject. However, a program is executed by a processor (e.g., CPU (Central Processing Unit)), thereby performing a predetermined process by properly using at least one of a storage device (for example, a memory) and a communication interface device (for example, a communication port), and thus the subject of a process may be a processor. The process that is explained with a program as the subject, may be a process that is performed by a processor or a management system having the processor (for example, a computer for display or a management server). Also, a processor may be a CPU itself or may include a hardware circuit that performs a portion of or an entire process performed by a processor. A program may be installed from a program source to each controller. The program source may be, for example, a program distribution server or a storage media. The program distribution server may be a computer for management.

Moreover, in the explanation below, an electronic tag is pasted on a graph and the electronic tag is mentioned as “memo.” Furthermore, a graph represents a time-series variation of a measurement value of a certain metric concerning a monitoring target of the management system and the measurement value corresponding to a metric, is mentioned as “metric value.” Additionally, a metric is an example of standpoints. A measurement value is an example of values. A monitoring target is an example of targets managed by the management system.

Also, in the explanation below, an ID or a name is used as identification information of various targets (such as a memo and a metric); however, the ID and the name may be mutually replaceable, or another type of identification information may be used instead of at least one of them or additionally.

Moreover, the management system may be configured of one or more computers. Specifically, for example, when a management computer displays information (specifically, when a management computer displays information on a display device thereof or a management computer transmits information for display to a remote computer for display), the management computer is the management system. Also, for example, when the similar functions to those of the management computer are achieved by a plurality of computers, the plurality of computers (which may include a computer for display when display is performed by the computer for display) are the management system. Additionally, the management system may be a combination of a management computer (management server) and a computer for display. In the following embodiment, a management server is the management system.

Furthermore, in the explanation below, a “character string” is configured of a plurality of characters; however, at least one character may be a number, sign, or symbol.

Additionally, in the explanation below, a “time point” is defined by year, month, day, hour, minute, and second; however, a unit of time point may be larger or smaller than the unit.

Also, in the explanation below, the operation by a user (for example, a manager) onto a displaying GUI (Graphical User Interface) screen with the use of an input device is termed as “user operation.” Additionally, the specific examples of the user operation include depressing a key, clicking, double-clicking, and overlapping a cursor of a pointing device (such as a mouse). An operation such as clicking or double-clicking may be pressing a button of a pointing device or touching a touch screen. Moreover, the user operation may include a zoom-in operation or a zoom-out operation. The zoom-in operation may include, for example, scrolling-up a mouse wheel with a cursor placed over a GUI object, or performing pinch-in over a GUI object on a touch screen. The zoom-out operation may include, for example, scrolling-down a mouse wheel with a cursor placed over a GUI object, or performing pinch-out over a GUI object on a touch screen.

Additionally, in the explanation below, a graph having the first axis and the second axis is a graph in the orthogonal coordinate system. The first axis may be a horizontal axis or a vertical axis; however, the first axis is a horizontal axis in the following explanation. The second axis may be a horizontal axis or a vertical axis, but is a vertical axis in the following explanation. Furthermore, in the explanation below, the graph has a third axis parallel to the second axis, and the third axis is also a vertical axis. Specifically, the second axis is a left axis (left vertical axis), and the third axis is a right axis (right vertical axis).

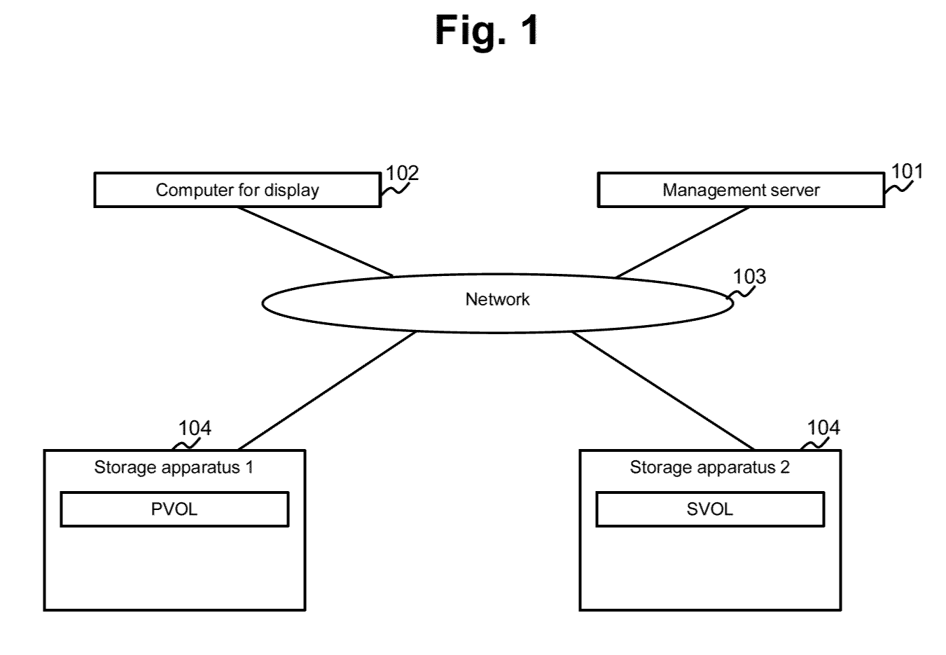

FIG. 1 shows a configuration of a computer system according to an embodiment.

The computer system has one or more monitoring target apparatuses 104, a computer for display 102, and a management server 101 that is communicably coupled thereto through a communication network (for example, IP (Internet Protocol) network) 103.

The monitoring target apparatus 104 is a monitoring target or an apparatus having a monitoring target. The one or more monitoring target apparatuses 104 may include, for example, two storage apparatuses. The two storage apparatuses have a logical volume for storing data respectively. Between the two storage apparatuses, so-called remote copying is performed. For example, a VOL pair is configured of PVOL (primary logical volume) of a storage apparatus 1 and SVOL (secondary logical volume) of a storage apparatus 2. Data is stored in the PVOL of the storage apparatus 1 by a host, etc., and the stored data is copied from the PVOL of the storage apparatus 1 to the SVOL of the storage apparatus 2.

The monitoring target apparatus 104 certainly may be another apparatus instead of or in addition to a storage apparatus. For example, the monitoring target apparatus 104 may be a host computer that issues an I/O (Input/Output) request to a storage apparatus.

A monitoring target may be a physical target or a logical target. Also, there may be one or a plurality of monitoring targets existing in one monitoring target apparatus 104. When the monitoring target apparatus 104 is a storage apparatus, the monitoring target as a physical target may be a port, processor, physical storage device or the like, and the monitoring target as a logical target may be a logical volume.

Moreover, there may be one or a plurality of metrics for one monitoring target. When the monitoring target is the SVOL, the metric includes, for example, write delay time (difference between the time point when data is written in the PVOL and the time point when data is written in the SVOL), a cache write pending rate (probability that writing into a cache memory is made to wait in copying data from the PVOL to the SVOL), and a processor busy rate (processor load in copying data from the PVOL to the SVOL).

The management server 101 is a computer that can collect and accumulate a metric information unit from the monitoring target apparatus 104 and can receive user operation information (information representing details of user operation) from the computer for display 102. The computer for display 102 is a computer having a display device where information output from the management server 101 is displayed. Furthermore, an “information unit” is information that corresponds to one record of a table.

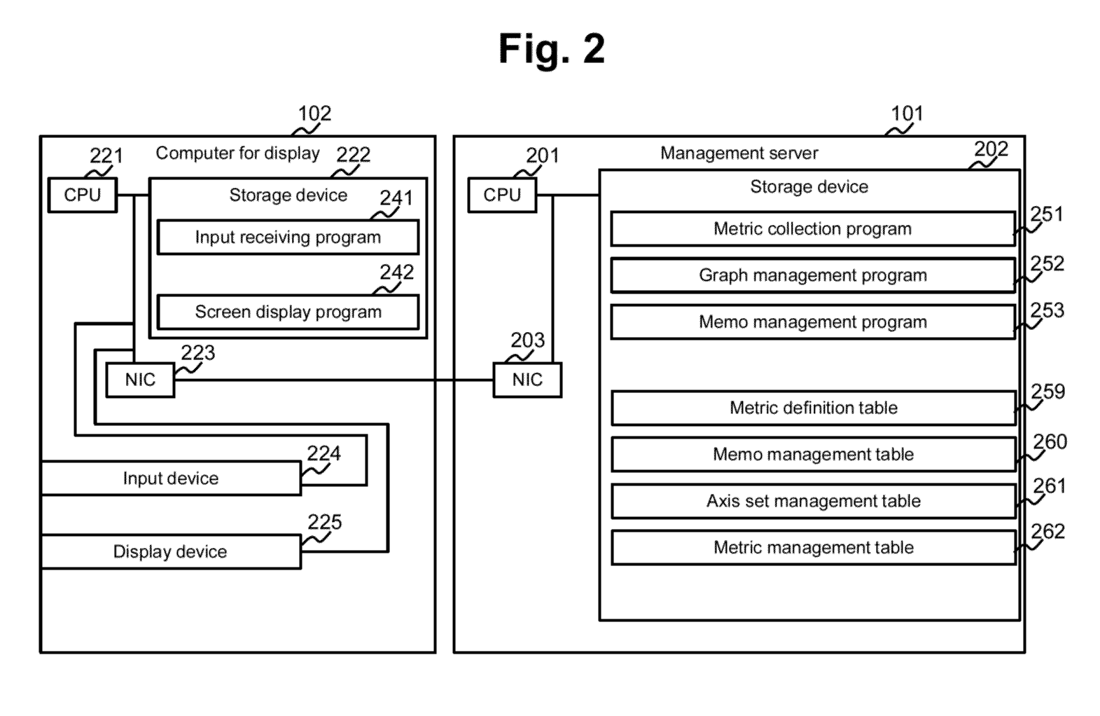

FIG. 2 shows a configuration of the management server 101 and the computer for display 102 respectively.

The computer for display 102 includes an I/O (Input/Output) interface device, a storage device 222, an input device 224, a display device 225, and a CPU (Central Processing Unit) 221 coupled thereto. The I/O interface device may be a communication interface device such as a NIC (Network Interface Card) 223. The input device 224 may be, for example, a keyboard and a pointing device. The display device 225 may be, for example, a liquid crystal display. The input device 224 and the display device 225 may be in one body like a touch screen. The storage device 222 may include a main storage memory and an auxiliary storage device. The storage device 222 stores a computer program executed by the CPU 221. As the computer program, for example, there is an input receiving program 241 and a screen display program 242. The input receiving program 241 can receive information through the input device 224 from a user who is using the computer for display 102, and can transmit the information to the management server 101 through the NIC 223. The screen display program 242 can display the information received from the management server 101 through the NIC 223 on the display device 225. The input receiving program 241 and the screen display program 242 may be, for example, a Web browser.

The management server 101 has an I/O (Input/Output) interface device, a storage device 202, and a CPU 201 coupled thereto. The I/O interface device may be a communication interface device such as a NIC (Network Interface Card) 203. The I/O interface device may be an input device and a display device in a broad sense (for example, when the management server 101 and the computer for display 102 are in one body). The storage device 202 may include a main storage memory and an auxiliary storage device. The auxiliary storage device may be built in the management server 101 or may exist externally. The auxiliary storage device is typically a nonvolatile storage device. The auxiliary storage device may be a disk type storage device such as an HDD (Hard Disk Drive), a memory device such as an SSD (Solid State Device) or a storage apparatus having a RAID group. The storage apparatus may be one of the monitoring target apparatuses.

According to the configuration of FIG. 2, information is input as below. Namely, the information that is input by a user to the computer for display 102 through the input device 224, is transmitted from the input receiving program 241 to the management server 101, and the management server 101 receives the input information. In the explanation below, in order to avoid redundancy of the explanation, the flow like this may be explained in such an abbreviated manner as that the management server 101 receives the information input by a user or information is input to the management server 101 by a user.

Also, according to the configuration of FIG. 2, information is displayed as follows. Namely, the management server 101 draws information of a display target (such as images and characters) in the storage device 202 (typically a main storage memory). The drawn information is transmitted to the computer for display 102, and the screen display program 242 displays the information on the display device 225. In the explanation below, in order to avoid redundancy of the explanation, the flow like this may be explained in such an abbreviated manner as that the management server 101 displays information. Moreover, for the explanation below, writing information of a display target into a storage device such as main storage memory is called “drawing”, and is distinguished from the display of information. “Display” mentioned in this embodiment may mean that drawn information is transmitted to the computer for display 102 by the management server 101 and the information is visibly output at the display device 225.

The storage device 202 of the management server 101 stores a computer program executed by the CPU 201 and the information used by the CPU 201. The computer program includes, for example, a metric collection program 251, a graph management program 252, and a memo management program 253. The information includes, for example, a metric definition table 259, a memo management table 260, an axis set management table 261, and a metric management table 262.

The metric collection program 251 collects the metric information unit from each monitoring target apparatus 104. One metric information unit corresponds to one monitoring target and one metric. Specifically, one metric information unit may include a monitoring target ID, a metric ID, a time point (measurement time point), and a metric value. Each monitoring target apparatus 104 may accumulate, for the monitoring target, the metric information unit including a metric value concerning the monitoring target and a metric ID corresponding to the metric value, and may transmit the accumulated metric information unit to the management server 101. The metric collection program 251 registers information in the collected metric information unit to a database, typically, the metric management table 262.

The graph management program 252 draws (creates) a graph screen on the basis of the metric management table 262, and displays the drawn graph screen. In the process, the graph management program 252 determines whether or not there is a memo that needs to be pasted on a graph in a graph screen (memo that needs to be drawn on a graph) on the basis of the memo management table 260, and pastes the memo on the graph if there is such a memo. Additionally, in this embodiment, the graph is a graph in the orthogonal coordinate system as mentioned above, and has a horizontal axis, a left axis, and a right axis. The horizontal axis is an axis that corresponds to time, however a user can change metrics corresponding to the left and right axis, respectively. The graph management program 252 receives each designation of a metric to be corresponded to the left axis and a metric to be corresponded to the right axis from a user, and registers an information unit that represents an axis set, which is a correspondence relation between the left axis metric and the right axis metric, to the axis set management table 261. The graph management program 252 draws a graph screen having a graph in accordance with the correspondence relation specified by the axis set management table 261. Metrics that correspond to the left axis may be called “left metrics” and metrics that correspond to the right axis may be called “right metrics” below.

The memo management program 253 receives information that represents a memo pasting operation to the displayed graph, and pastes a memo (for example, a blank memo) on memo coordinates as coordinates where the memo pasting operation has been performed. “Memo pasting operation” is a user operation for instructing to paste a memo. “Memo coordinates” are the coordinates at a position where the memo is pasted, and may be configured of a time point and a left metric value (a metric value corresponding to a left metric). The time point corresponds to an x coordinate, and the left metric value corresponds to a y coordinate. Moreover, the memo coordinates may include a right metric value (a metric value corresponding to a right metric); however, in this embodiment, the memo coordinates are defined by a time point and a left metric value even when including a right metric value. This is because the left axis is prioritized over the right axis. Furthermore, when the right axis is prioritized over the left axis, the memo coordinates may be defined by a time point and a right metric value. The memo management program 253 receives the user operation information that represents a character input operation for a pasted memo, and draws and displays characters in accordance with the character input operation (in other words, characters input by a user). The character input operation is a user operation for instructing a character input (for example, a key input). The memo management program 253 registers a memo information unit into the memo management table 260. The memo information unit includes memo coordinates, a memo text, etc. Also, the memo management program 253 receives the user operation information that represents a list display operation, and draws and displays a memo list. “List display operation” is a user operation for instructing to display a memo list. “Memo list” may be configured of a plurality of memo objects that correspond to a plurality of memos respectively. “Memo object” is an object representing a memo. For example, the memo object may be a character string including information in a memo information unit, or may be an icon such as a mark representing the memo. Additionally, the memo management program 253 can receive the user operation information that represents a memo moving operation, and move a memo in a graph. The program can receive the user operation information that represents a memo deleting operation, and delete a selected memo. The program can receive the user operation information that represents a memo editing operation, and edit a character string in a selected memo. “Memo moving operation” is a user operation to instruct to move a memo; “memo deleting operation” is a user operation to instruct to delete a memo; and “memo editing operation” is a user operation to instruct to edit a character string in a memo. Also, the memo management program 253 receives the user operation information that represents a graph activation operation, and instructs the graph management program 252 to activate (draw (create) and display) a graph to which a memo corresponding to a memo object selected from a memo list is pasted. The graph management program 252 displays a graph to which a memo corresponding to a memo object selected from a memo list is pasted, in response to the instruction. “Graph activation operation” is a user operation to instruct displaying a graph to which a memo corresponding to a memo object selected from a memo list, is pasted. Additionally, the memo management program 253 receives the user operation information representing a memo search operation, and searches the memo that matches conditions designated by the memo search operation, from the memo management table 260, and draws and displays the search results as a memo list. “Memo search operation” is a user operation to instruct to search for a memo by designating the conditions of the memo as a search target. For example, it is considered that search conditions are such as having a character string including a keyword input by a user, corresponding to memo coordinates including a time point within a time point range designated by a user, and corresponding to memo coordinates including a metric value corresponding to a metric designated by a user.

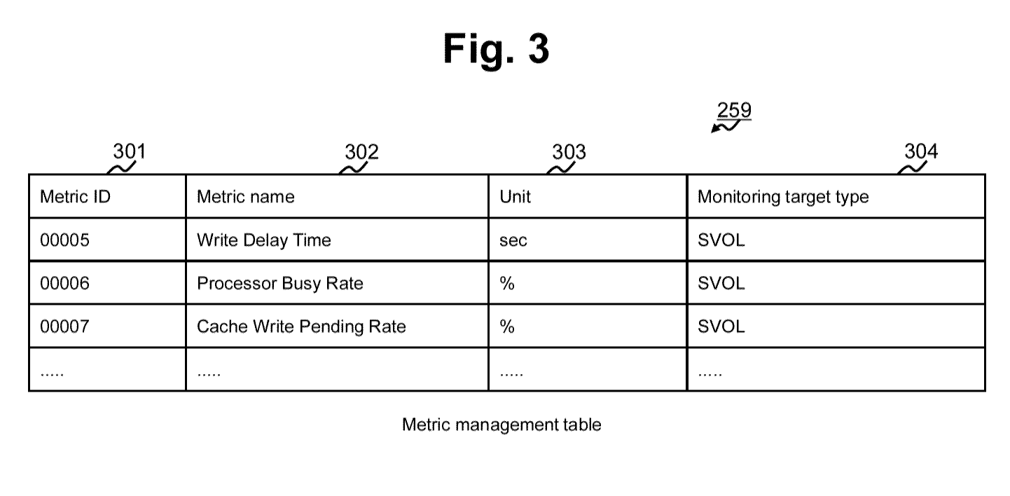

FIG. 3 shows the metric definition table 259.

The metric definition table 259 has information relating to each metric. For example, the metric definition table 259 has a record per metric. To each record, information called a metric ID 301, a metric name 302, a unit 303, and a monitoring target type 304 is registered. The metric ID 301 is the ID of a metric. The metric name 302 represents the name of a metric. The unit 303 represents a unit of a metric value. The monitoring target type 304 represents a monitoring target type (such as an SVOL, a PVOL, a processor, a port, and a cache memory) to which metrics may be employed.

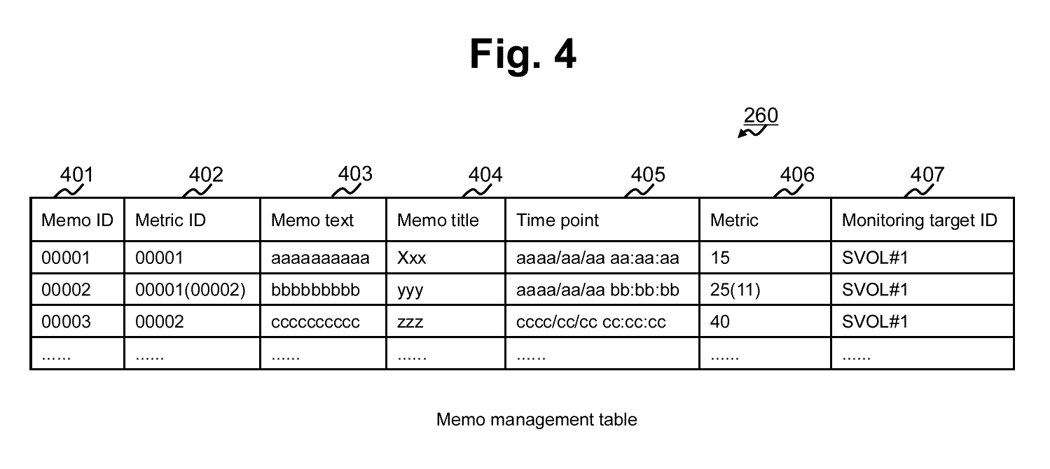

FIG. 4 shows the memo management table 260.

The memo management table 260 has information relating to each memo. For example, the memo management table 260 has a record per memo. To each record, information called a memo ID 401, a metric ID 402, a memo text 403, a memo title 404, memo coordinates 405, and a monitoring target ID 406 is registered. The memo ID 401 is the ID of a memo. The metric ID 402 is the ID of a left metric. The memo text 403 represents a character string input by a user as a memo text. The memo title 404 represents a character string input by a user as a memo title. The memo coordinates 405 represent coordinates that is configured of a time point and a left metric value. The monitoring target ID 406 is the ID of a monitoring target. For example, when a monitoring target is the SVOL, the monitoring target ID may be a combination of a serial number of a storage apparatus, WWN (World Wide Name) of a port of the storage apparatus, and a logical volume number. Also, the metric ID 402 may include the ID of a right metric, and the memo coordinates 405 may include a right metric value (numbers in brackets at the record of memo ID 401 “00002” are a right metric ID and a right metric value).

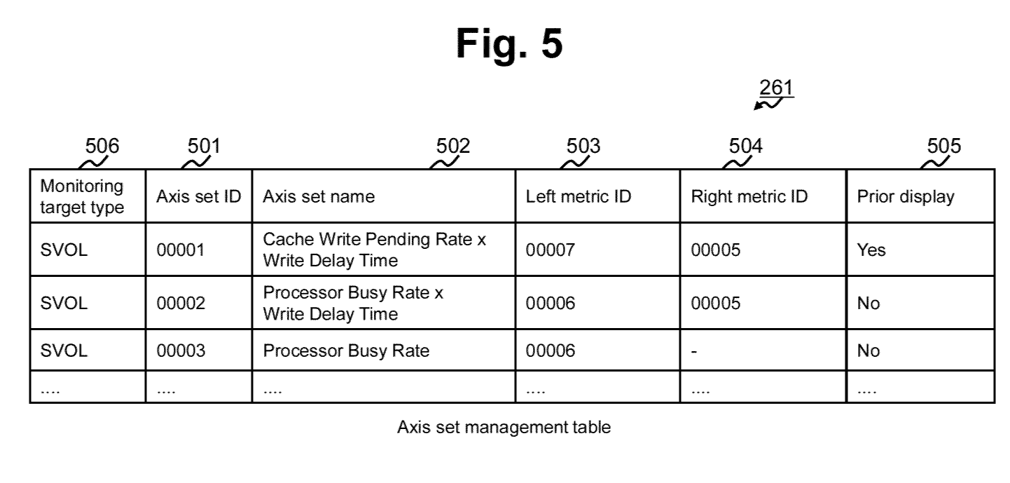

FIG. 5 shows the axis set management table 261.

The axis set management table 261 has information relating to each axis set. For example, the axis set management table 261 has a record per axis set. To each record, information called an axis set ID 501, an axis set name 502, a left metric ID 503, a right metric ID 504, a prior display 505, and a monitoring target type 506 is registered. The axis set ID 501 is the ID of an axis set. The axis set name 502 is a combination of a left metric name and a right metric name, and the left metric name is in the front. The left metric ID 503 is the ID of a left metric. The right metric ID 504 is the ID of a right metric. The prior display 505 is whether or not an axis set is prioritized. Only to one axis set among a plurality of axis sets, “Yes” which means to prioritize, is registered. The monitoring target type 506 represents a type of monitoring targets. The types of monitoring targets include an SVOL, a PVOL, and a processor. Moreover, in this embodiment, a graph with no right axis may be displayed. Regarding an axis set for such a graph, the right metric name and the right metric ID may be blank in FIG. 5 (for example, see the record where the axis set ID “00003” is registered).

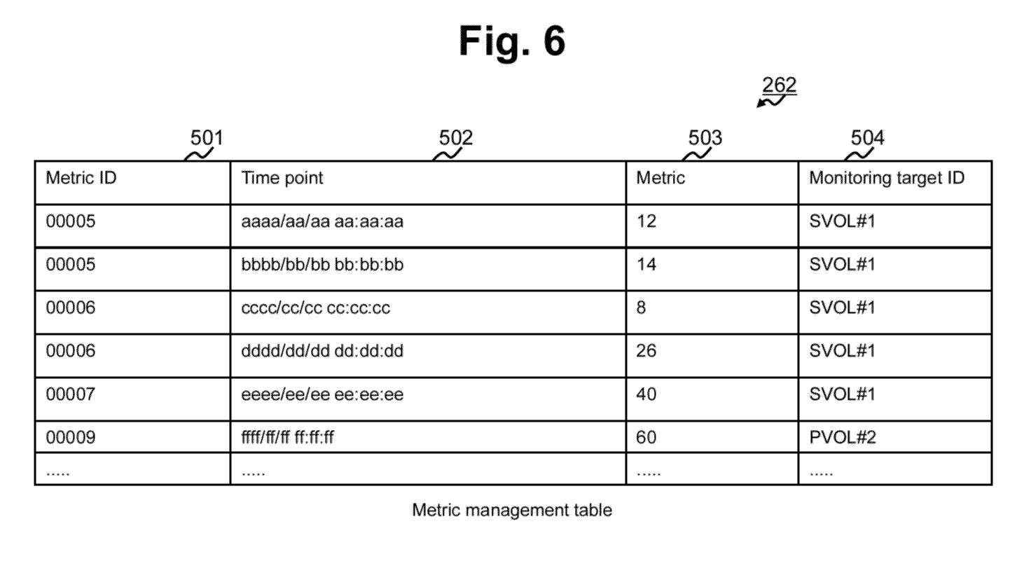

FIG. 6 shows the metric management table 262.

The metric management table 262 has information relating to each metric value. For example, the metric management table 262 has a record per metric value. To each record, information called a metric ID 601, a time point 602, a metric value 603, and a monitoring target ID 604 is registered. To one record, information 601 to 604 is registered as information included in the above-described metric information unit collected from the monitoring target apparatus 104. The metric ID 601 is the ID of a metric. The time point 602 represents a time point when a metric value is obtained (in other words, measurement time point). The metric value 603 represents a metric value. The monitoring target ID 604 is the ID of a monitoring target for which a metric value is obtained.

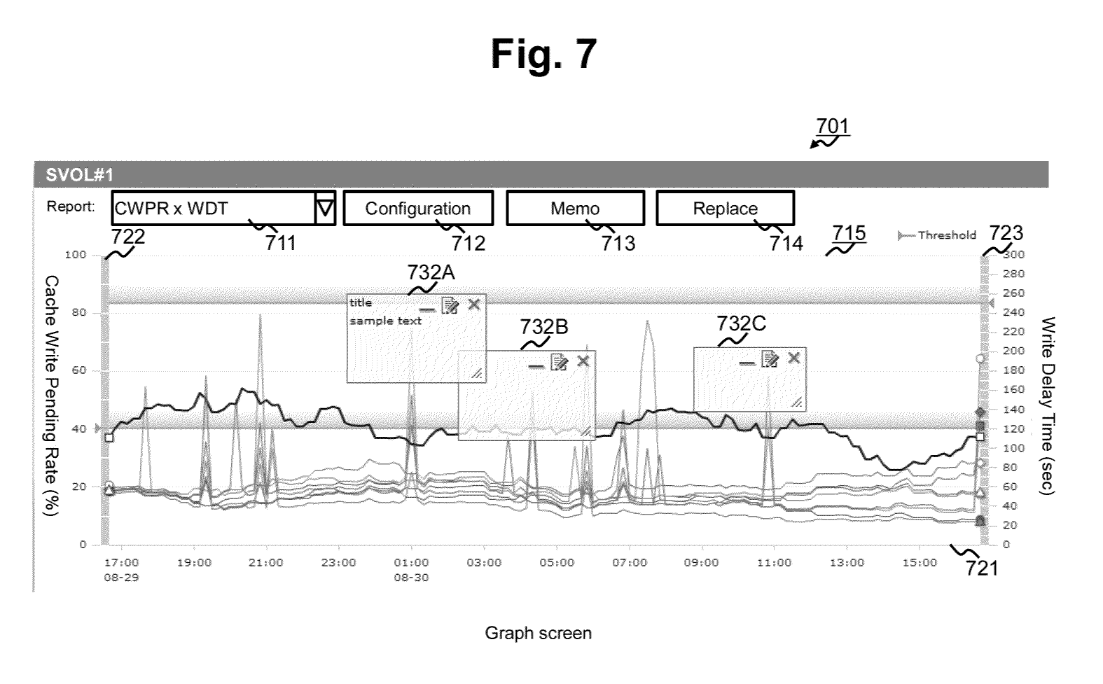

FIG. 7 shows an example of a graph screen.

In the graph screen 701, an axis set selecting object 711, a graph configuring object 712, a memo creating object 713, a replacement designating object 714, and a graph 715 are displayed. The graph screen 701 is drawn and displayed by the graph management program 252. The graph screen 701 shown in FIG. 7 is a screen for representing the monitoring results of the SVOL (time-series variation of metric value).

The axis set selecting object 711 is a GUI object (such as a pull⁻down menu) to designate a desired axis set by a user from axis sets corresponding to the type of a monitoring target, which is a graph displaying target. According to the example shown in FIG. 7, selected is an axis set where the left metric is the cache write pending rate and the right metric is the write delay time. Alternatively, the axis set may be an axis set of prior display target (default axis set).

The graph configuring object 712 is a GUI object (such as a button) that is operated by a user so as to configure an axis set.

The memo creating object 713 is a GUI object (such as a button) that is operated by a user so as to create a new memo.

The replacement designating object 714 is a GUI object (such as a button) that is operated by a user so as to replace a left metric with a right metric for the graph 715. Additionally, instead of such replacement, switching so as to prioritize a right axis over a left axis may be employed.

The graph 715 is a graph in the orthogonal coordinate system having at least a horizontal axis 721 and a left axis 722. Further, as shown in FIG. 7, the graph 715 may also have a right axis 723. The horizontal axis 721 corresponds to time. The left axis 722 and the right axis 723 correspond to the axis set (left metric and right metric) designated by the object 711. The graph 715 represents a time-series variation of the left metric value in a display target time point range and a time-series variation of the right metric value in a display target time point range. “Display target time point range” is the display range of the horizontal axis (time axis) 721.

The graph management program 252 specifies a plurality of records corresponding to the ID of the monitoring target (the SVOL) and the metric ID of the left metric (in particular, records to which time points within the display target time point range are registered) from the metric management table 262. Then, on the basis of the plurality of time points and the plurality of metric values registered in the specified plurality of records, the graph management program 252 draws a graph object (such as a broken line) that represents the time-series variation of the left metric value in a plot area in a graph. Similarly, the graph management program 252 specifies a plurality of records corresponding to the ID of the monitoring target (the SVOL) and the metric ID of the right metric (in particular, records to which time points within the display target time point range are registered) from the metric management table 262. Then, on the basis of the plurality of time points and the plurality of metric values registered in the specified plurality of records, the graph management program 252 draws a graph object (such as a broken line) that represents the time-series variation of the right metric value in the same plot area.

Moreover, the graph management program 252 specifies a record with registered memo coordinates that include a time point included in the display target time point range and left metric value, from the memo management table 260, and draws a memo corresponding to the specified record on the graph 715. According to FIG. 7, three memos 732A, 732B and 732C are drawn. Each memo is rectangular, and top left corner thereof is memo coordinates of the memo.

Each memo has a memo title and a memo text. A user can enter characters to any of the memo title and the memo text. The display size (area) of the memo may be fixed or may be variable depending on the amount of character strings in the memo text. When at least a portion of the displayed plurality of memos overlap each other, the overlapping method may be determined by a predetermined policy. For example, the memo management program 253 may display a memo with the oldest time point in memo coordinates, at the forefront, or may display a memo with a time point, at which most recently editing has been done by a user, at the forefront. The time points edited by a user may be registered to e.g., the memo management table 260 per memo.

The display target time point range varies by horizontally scrolling (scrolling to the right or the left) the graph 715, or by the variation of magnification ratios (zoom-out or zoom-in) of the graph 715. When the display target time point range changes, the display position of each coordinates changes in the graph 715. However, since the memos (732A to 732C) are fixed to the coordinates, they certainly move along with the variation in display target time point ranges.

The memo management program 253 may display a blank memo (for example, 732C) at a predetermined position on the graph screen 701 when the memo creating object 713 is operated. Additionally, the memo management program 253 may paste a blank memo in response to a memo pasting operation (for example, a double click at the coordinates desired by a user on the graph 715). According to the memo pasting operation, memo coordinates are designated. The memo management program 253 pastes a memo by using the designated memo coordinates as reference coordinates. In this embodiment, the reference coordinates are coordinates at the top left corner of a memo. Although memos are rectangular in this embodiment, the shape is not limited thereto.

The memo management program 253, in response to a memo moving operation to a designated memo (“target memo” (e.g., 732B) in this column), moves the target memo on the graph 715. The memo management program 253 updates the time point and the left metric value (and the right metric value) in the memo coordinates 405 corresponding to the target memo before moving, to a time point and a left metric value (and a right metric value) in memo coordinates of the target memo after moving.

The memo management program 253, in response to a memo deleting operation to a designated memo (“target memo (for example, 732C)” in this column), deletes the target memo from the graph 715, and deletes the information from the target record (the record corresponding to the target memo) in the memo management table 260.

The graph management program 252 detects that the replacement designating object 714 is operated, replacing the left metric with the right metric. In other words, the right metric is changed to the left metric (new left metric), and the left metric is changed to the right metric (new right metric). The graph management program 252 deletes at least a memo that corresponds to memo coordinates including no new left metrics, from the graph 715 among memos that were displayed before operating the replacement designating object 714. Moreover, the graph management program 252 displays a memo that correspond to memo coordinates including a time point included in the display target time point range and the metric value of the new left metric, on the graph 715. Thus, regarding an axis set desired by a user, a memo associated with a right metric (new left metric) can be confirmed by simply replacing a left metric with a right metric.

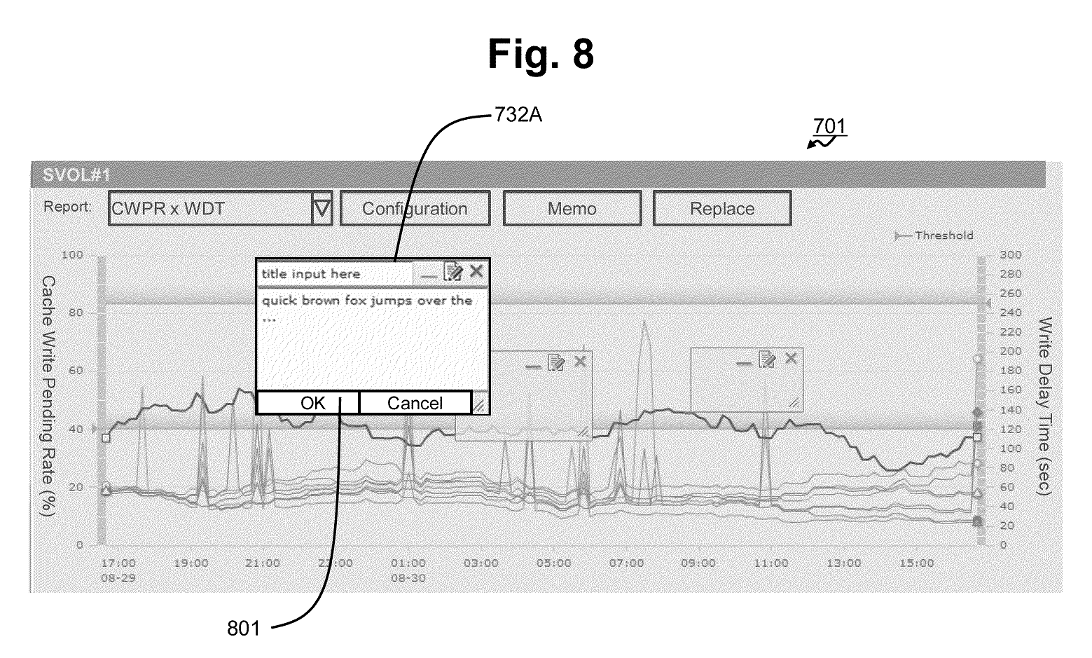

FIG. 8 shows an example of a screen when a memo is pasted.

The memo management program 253 pastes a memo (732A) in response to a memo pasting operation, assigns a memo ID to the pasted memo, enables the pasted memo and disables a predetermined range, except for the pasted memo. The memo management program 253, in response to a character input operation to the pasted memo, displays characters input by a user in a memo title or a memo text. The memo management program 253, in response to a memo registering operation such as clicking an OK button 801, registers a memo information unit including memo coordinates of the pasted memo, the memo ID of the pasted memo, the character string of a memo text, the character string of the memo title, and the ID of the monitoring target corresponding to the graph 715, to the memo management table 260.

Additionally, a similar screen to that in FIG. 8 is also displayed when a memo title or a memo text of a memo on the graph 715 is edited. A memo registering operation is carried out after editing, and the information corresponding to a memo before editing in the memo management table 260 (memo text or memo title) is updated to the information corresponding to the edited memo.

Moreover, in a memo on a graph, the information of a user who has input a character string to the memo (such as a user ID, an organization to which a user belongs, and a name) may be displayed. Thereby it is understood who registered the memo.

According to the explanation above, the correspondence between the memo coordinate (the time and left metric value) and the memo is maintained, and the memo is displayed on a graph on the basis of the correspondence. In other words, the nature of graph display for showing a relationship between time points and metric values is well utilized, and the advantage of leaving memos relating to analytical results is guaranteed.

Also, according to the explanation above, the memo that is created, edited, or moved on the graph 715 by a user, is automatically arranged at memo coordinates defined by time points and left metric values in the displayed graph 715 when the graph 715 is closed once and displayed again. Namely, memos are visible while a correspondence relation between time points and left metric values, and memos is maintained.

Also, according to the explanation above, memo coordinates are defined by time points and left metric values. Thus, it is possible to display memos on any of the plurality of graphs having the same left metric and different right metrics. Moreover, when memo coordinates are defined by a time point, a left metric value, and a right metric value, a memo may be displayed on a graph where the right metric is also the same.

Also, according to the explanation above, although a monitoring target ID is registered to a memo information unit (a record on the memo management table 260), there may be no monitoring target ID. In this case, it is possible to display the same memo on each of the plurality of graphs having the same left metric and different monitoring target IDs (or types).

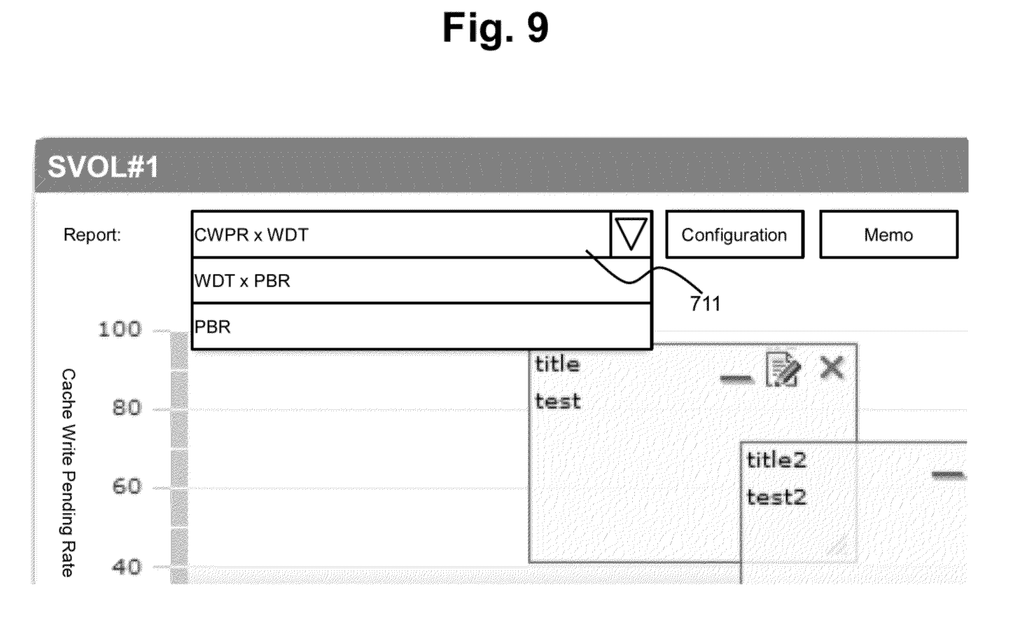

FIG. 9 shows a method of selecting the axis set.

When the axis set selecting object 711 is operated, a list of selectable axis sets is displayed by a pull-down. The list of axis sets may be a list of axis set names 502 corresponding to the monitoring target ID corresponding to the graph 715, in the axis set management table 261. When a desired axis set is selected by a user, another graph in accordance with the selected axis set is drawn and displayed instead of or in front of the graph 715 in FIG. 7 by the graph management program 252. Thus, a user can display a graph that represents the time-series variation of metric value for a desired metric just by changing the desired axis set from the plurality of axis sets that are registered in advance.

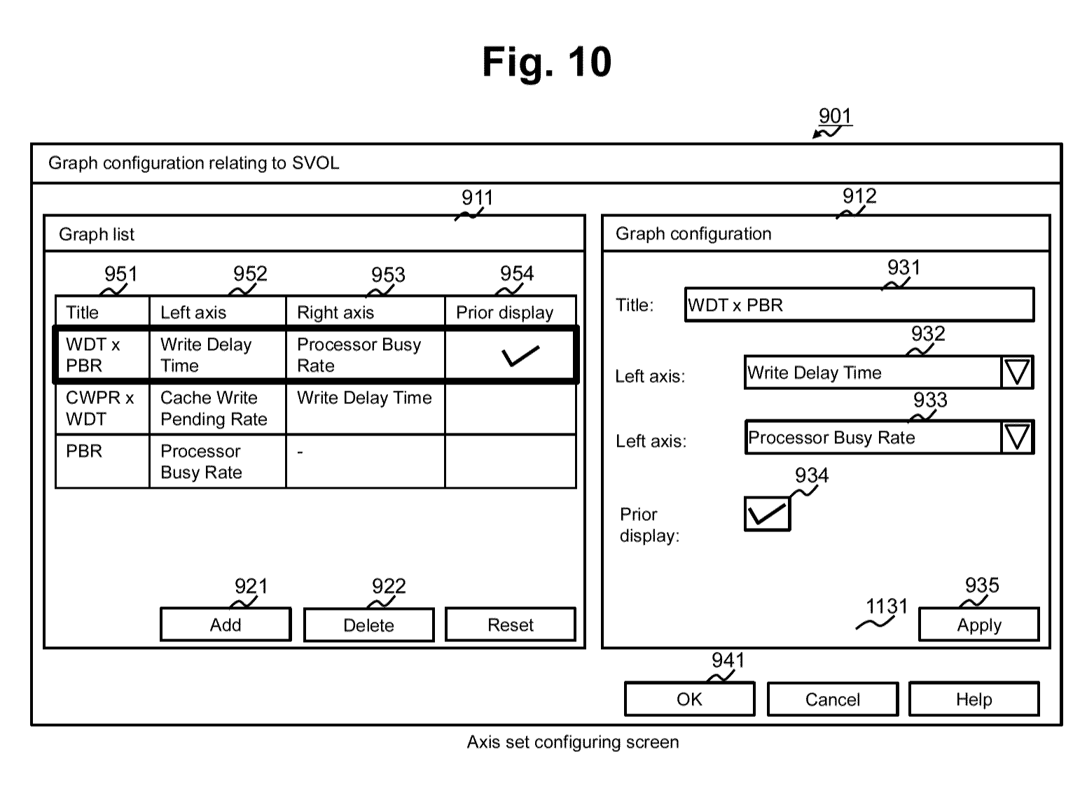

FIG. 10 shows an example of an axis set configuring screen.

The axis set configuring screen 901 is drawn and displayed by the graph management program 252 when the graph configuring object 712 is operated. A user can configure axis sets through the axis set configuring screen 901.

The axis set configuring screen 901 has a graph list screen 911, a graph configuring screen 912, and an OK button 941.

The graph list screen 911 displays a list of information relating to a previously configured axis set (an axis set corresponding to the information that was previously registered in the axis set management table 261). For example, the graph list screen 911 has a title 951, a left axis 952, a right axis 953, and a prior display 954 per previously configured axis set. The title 951 represents the axis set name 502 of an axis set. The left axis 952 represents the metric name 302 corresponding to the left metric ID 503 corresponding to the axis set. The right axis 953 represents the metric name 302 corresponding to the right metric ID 504 corresponding to the axis set. The prior display 954 represents the prior display 505 corresponding to the axis set (a check mark is displayed for the axis set that corresponds to the prior display 505 “Yes”).

Additionally, the graph list screen 911 has an add button 921 and a delete button 922. When the add button 921 is pressed, the graph management program 252 receives the input of information relating to a new axis set on the graph configuring screen 912. When a user selects an axis set from the graph list screen 911 and presses the delete button 922, the graph management program 252 deletes information corresponding to the selected axis set from the graph list screen 911 and the axis set management table 261.

The graph configuring screen 912 is a screen for receiving the input of information relating to the axis set. The graph configuring screen 912 has a title inputting object 931, a left axis designating object 923, a right axis designating object 933, a prior display designating object 934, and the above-described application button 935. The title inputting object 931 is an input box for a title (name) of the axis set. The left axis designating object 932 is a GUI object (for example, a pull-down menu) so as to designate the name of metrics that can be corresponded to the left axis. The right axis designating object 933 is a GUI object (for example, a pull-down menu) so as to designate the name of metrics that can be corresponded to the right axis. Prior display designating object 934 is a GUI object (such as a check box) for designating whether or not prior display is executed. A list of names displayed by the objects 933 and 934 is properly controlled by the graph management program 252. For example, the list may be a list of metric names 302 corresponding to monitoring target types. Also, the list of names is controlled so as not to select the same metric names at the left axis and the right axis. The graph management program 252 reflects the information input to the graph configuring screen 912 on the graph list screen 911 when the application button 935 is pressed.

The graph management program 252 registers the information based on the information input to the graph configuring screen 912 (the information reflected on the graph list screen 911) to the axis set management table 261 when the OK button 941 is pressed. For example, regarding a new axis set, an axis set ID is assigned to the axis set by the graph management program 252, and the information representing a monitoring target type is registered as a monitoring target type 506. The assigned axis set ID is registered as an axis set ID 501. The character string input to the title inputting object 931 is registered as an axis set name 502. The metric ID that corresponds to the metric name selected by the left axis designating object 932, is registered as a left metric ID 503 on the basis of the metric definition table 259. The metric ID that corresponds to the metric name selected by the right axis designating object 933, is registered as a right metric ID 504 on the basis of the metric definition table 259. Yes or No, in accordance with whether or not the prior display designating object 934 is checked, is registered as a prior display 505.

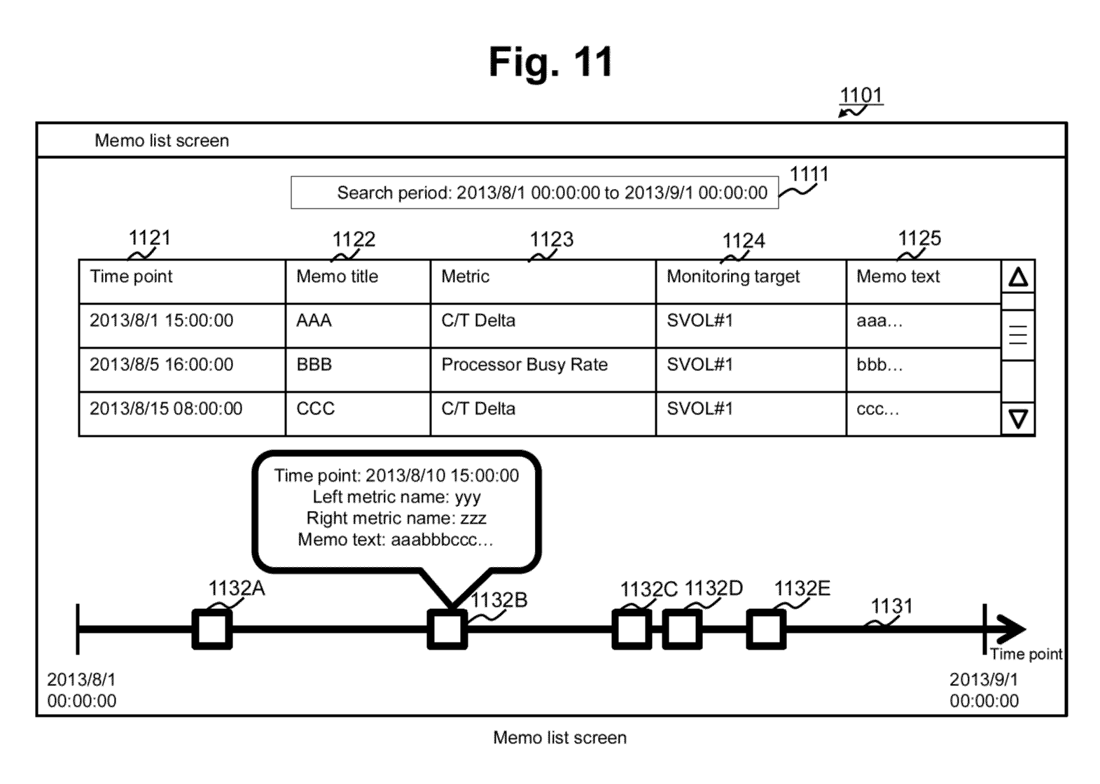

FIG. 11 shows an example of a memo list screen.

A memo list screen 1101 is a screen that is drawn and displayed by the memo management program 253, displaying a list of information relating to the whole or a portion of memos registered at the memo management table 260. The memo list screen 1101 in FIG. 11 is an example of the search result screen. The memo management program 253, in response to a memo search operation, can search the memo management table 206 for a memo that matches search conditions in accordance with the memo search operation, and can display the memo list screen 1101 as a screen representing the search results. In the explanation of FIG. 11, a memo that matches the search conditions, is called a “hit memo” hereinafter.

The memo list screen 1101 has a search period 1111, a first memo list 1112, and a second memo list 1113. In other words, the “memo list” includes at least one of the first and second memo lists.

The search period 1111 represents the conditions relating to a time point corresponding to a memo as the whole or a portion of search conditions. Searched are the memo included in the period represented by the search period 1111. Instead of or in addition to the period, other conditions (for example, a monitoring target type is “SVOL”, or a keyword “AA” is included in a memo title or a memo text) may be employed as the search conditions.

The first memo list 1112 is in a table form. The first memo list 1112 may be a table created on the basis of the memo management table 260 (and the metric definition table 259). For example, the first memo list 1112 has a memo object per hit memo. The memo object has a time point 1121, a memo title 1122, a metric 1123, a monitoring target 1124, and a memo text 1125. The time point 1121 represents time points in the memo coordinates 405 of a hit memo. The memo title 1122 represents a memo title 404 corresponding to the hit memo. The metric 1123 represents a metric name 302 corresponding to the metric ID 402 of the hit memo. The monitoring target 1124 represents a monitoring target ID 406 corresponding to the hit memo. The memo text 1125 represents the memo text 403 corresponding to the hit memo. The memo objects (table records) configuring the first memo list 1112 may be arranged in time-series.

The second memo list 1113 includes a number line 1131 with a time point as a number, and a plurality of memo objects (1132A to 1132E) arranged in time series along the number line 1131.

The range of numbers shown on the number line 1131 corresponds to a period represented by the search period 1111. That is, both ends of the number line 1131 correspond to the beginning and end of a period represented by the search period 1111. Each memo object on the number line 1131 is an icon for the hit memo. The position of the memo object of the hit memo on the number line 1131 is the position that corresponds to the time point in the memo coordinates of the hit memo.

When a user designates any of the memo objects (icons) (for example, 1132B) on the number line 1131 (for example, when a mouse cursor is placed over), the memo management program 253 displays a balloon 1141 where detailed information relating to the hit memo corresponding to the memo object is displayed. The detailed information may include, for example, a time point, a left metric name, a right metric name, and a memo text that are corresponding to the hit memo. In addition to the memo object designated by a user, the detailed information may be displayed at least for a memo object in the vicinity thereof.

A user can activate a graph which is pasted with a desired hit memo from the first memo list 1112 and also from the second memo list 1113. For example, a user performs a graph activation operation (for example, a double click) to a desired memo object (icon) in the second memo list 1113. The memo management program 253, in response to the graph activation operation, outputs a graph activation instruction including hit memo information (for example, memo ID) corresponding to the memo object, to the graph management program 252. The graph management program 252, in response to the graph activation instruction, specifies memo coordinates of the hit memo from the hit memo information, and draws and displays a graph (graph) in accordance with an axis set including a left metric corresponding to a left metric value in the memo coordinates. Also, when there is a plurality of axis sets including the same left metric, a graph, in accordance with an axis set for which the prior display 505 is “Yes”, may be displayed. When the plurality of axis sets including the same left metric has no axis set for which the prior display 505 is “Yes”, an axis set may be selected in accordance with a predetermined policy. The predetermined policy may be such as that the selected axis set has the largest number of memos corresponding to both the left metric and the right metric, or that the selected axis set is the most frequently selected.

Even at the first memo list 1112 and the second memo list 1113, a list of a plurality of memo objects corresponding to a plurality of memos pasted on a plurality of graphs, may be displayed. Accordingly, existence of a plurality of memos pasted on a plurality of graphs may be understood.

Also, even at the first memo list 1112 and the second memo list 1113, a list of a plurality of memo objects corresponding to a plurality of memos pasted on a plurality of graphs of a plurality of different monitoring targets, may be displayed. Accordingly, existence of a plurality of memos regarding a plurality of monitoring targets may be understood.

Moreover, for the management server 101, there may be a plurality of the computers for display 102. In other words, for the management server 101, there may be a plurality of users. Also, a plurality of memos registered by a plurality of users may be unitarily managed by the management server 101. Moreover, as long as a memo corresponds to the left metric of the graph, a memo that is registered by another user and corresponds to the same left metric as the left metric of the graph, in addition to a memo registered in the past by the user who has performed the display operation of the graph, may be displayed in the graph. In this case, each user can analyze time-series variation of metric value of monitoring targets on the basis of a memo registered by another user. Additionally, to each record in the memo management table 260, the user ID of a user who registered a memo may be registered. Furthermore, the storage device 202 of the management server 101 may store a user management table having information relating to each user. The user management table may include, for each user, a user ID, an organization to which a user belongs, a name, etc.

According to the explanation above, it is possible to search for a memo or sort out memos by using conditions relating to metric corresponding to memo text, time point in memo coordinates, or metric value in memo coordinates, as search conditions.

Also, according to the above explanation, a graph pasted with a memo may be activated from the first or the second memo list 1112 or 1113. Thus, a user operation is simple. Moreover, it is possible to understand the background (how data series have changed) of memos pasted by other users.

According to the above explanation, it may be understood that existence of memos at different monitoring targets and different metrics. Also, according to the configuration of the second memo list 1113, a user can easily understand a period when memos are crowded.

An example of each of some processes performed in this embodiment will be explained below. Additionally, in order to avoid redundancy of the explanation, it may be simply cited as that user operation is received, rather than that the management server 101 receives user operation information representing a user operation, in the explanation below. Also, in the explanation below, the input device 224 includes a keyboard and a mouse.

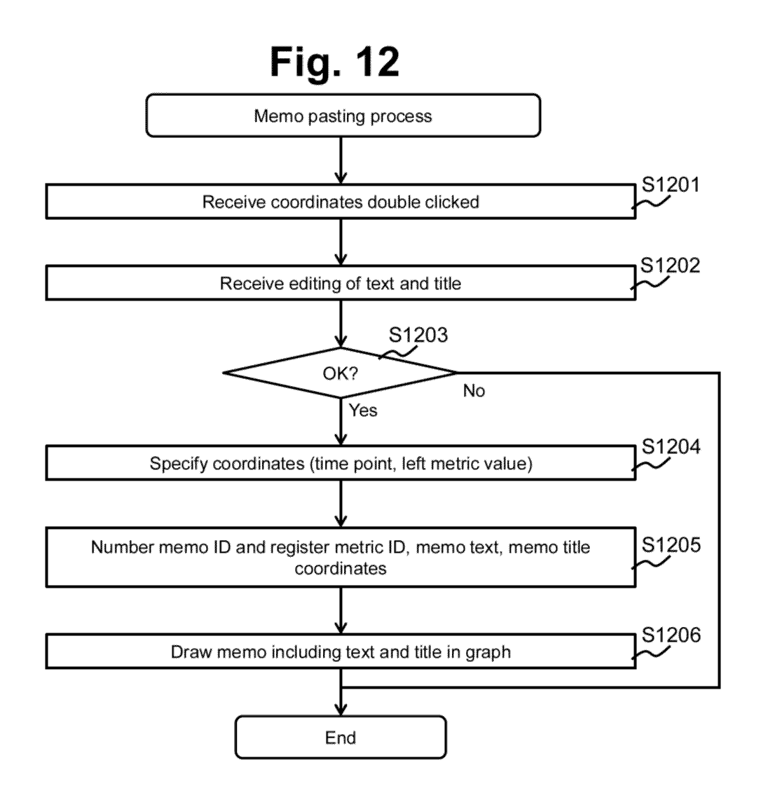

FIG. 12 shows a flow of a memo pasting process.

The graph management program 252 receives a memo pasting operation (S1201). In the memo pasting operation, coordinates are designated. The graph management program 252 receives a character input operation (editing operation) for a memo text and a memo title respectively (S1202).

When it is OK (for example, when an OK button, not shown, in a graph screen is pressed) (S1203: Yes), the graph management program 252 specifies a time point and a left metric value for the designated coordinates (S1204). The graph management program 252 numbers a memo ID and registers the memo ID, the metric ID (the metric ID of the left metric), the memo text the memo title, the time point specified in S1204, and the metric value specified in S1204, to the memo management table 260 (S1205). The graph management program 252 draws the memo having the memo text and the memo title at the designated memo coordinates (the time point and the metric value specified in S1204) in the graph (S1206).

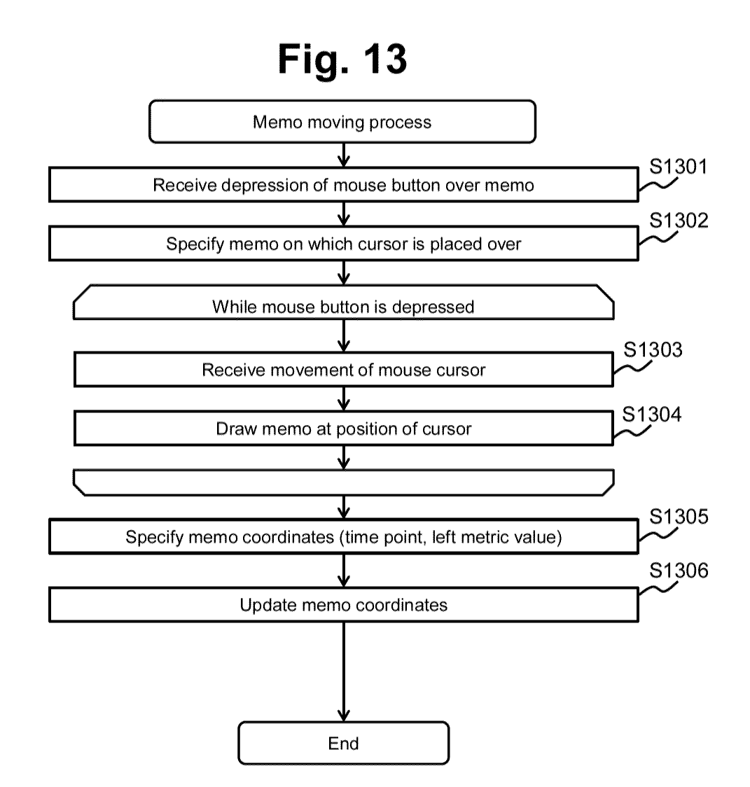

FIG. 13 shows a flow of a memo moving process. According to this memo moving process, the memo moving operation is so-called a drag-and-drop operation.

The memo management program 253 receives the depression of a mouse button while a mouse cursor is placed over a moving target memo (S1301), and, specifies the moving target memo under a mouse cursor (S1302).

While a mouse button is pressed, the memo management program 253, along with the movement of the mouse cursor (S1303), draws the memo under the mouse cursor (S1304). That is, the memo moves along with the mouse cursor.

At the point when the depression of a mouse button is released, the memo management program 253 specifies coordinates (the time point and the left metric value) at the top left corner of the memo under the mouse cursor (S1305) and registers the coordinates to the memo management table 260 (S1306).

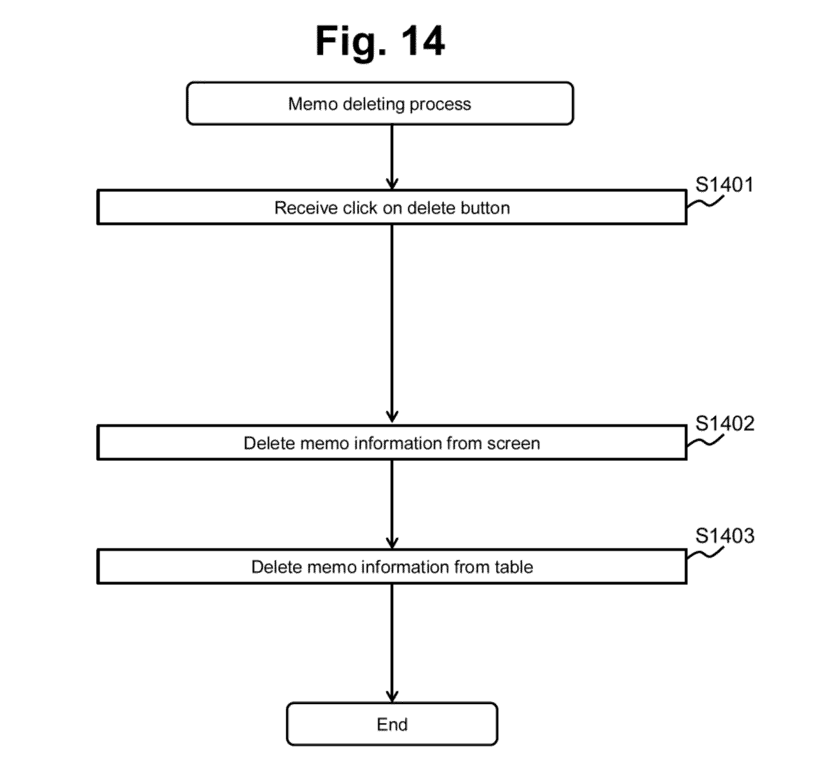

FIG. 14 shows a flow of a memo deleting process.

The memo management program 253 designates a deleting target memo and receives a click on a delete button (for example, the delete button 922 in FIG. 10) (S1401). The memo management program 253 deletes the information of the deleting target memo from the screen (S1402), and also deletes the information of the memo from the memo management table 260 (S1403).

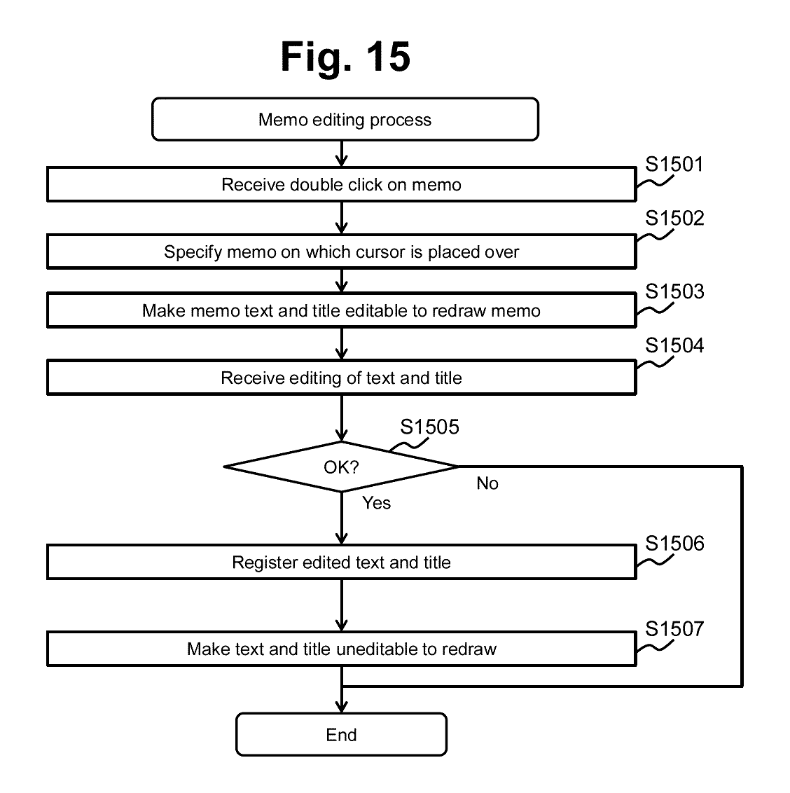

FIG. 15 shows a flow of a memo editing process.

The memo management program 253 receives a double click (or click of an editing button) while the mouse cursor is placed over an editing target memo (S1501), and specifies the editing target memo under the mouse cursor (S1502). The memo management program 253 makes the memo text and the memo title editable (enable) to redraw the memo (S1503), and receives character string editing for at least one of the memo text and the memo title (S1504).

If it is OK (for example, when the OK button 801 is clicked) (S1505: Yes), the memo management program 253 registers the edited memo text and the memo title to the memo management table 260 (S1506), and makes the memo text and the memo title uneditable (disable) to redraw the memo (S1507).

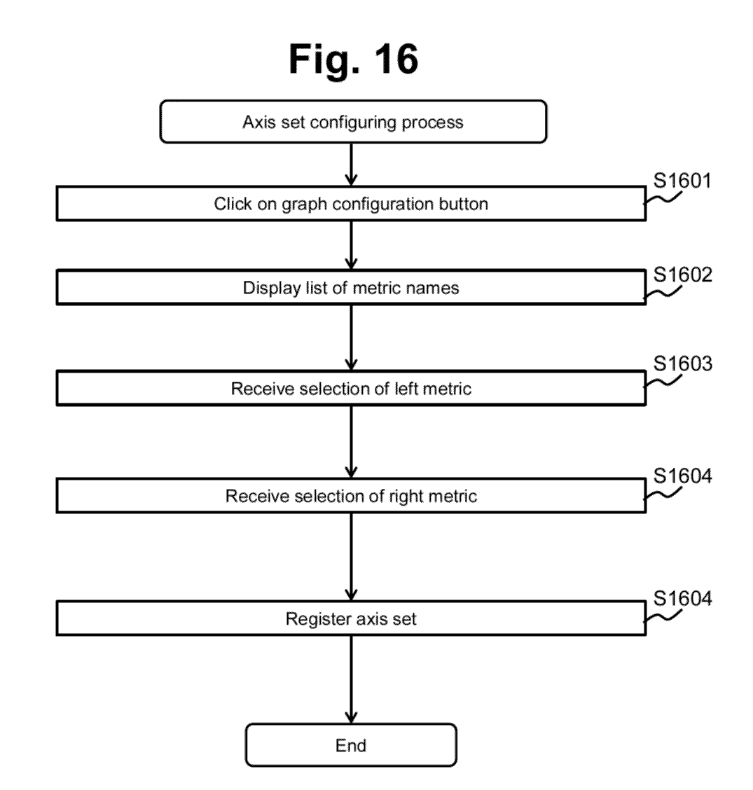

FIG. 16 shows a flow of flow of an axis set configuring process flow.

The graph management program 252 receives a click on the graph configuring object 712 (S1601), and draws the axis set configuring screen (see FIG. 10) (S1602). The graph management program 252 receives selection of a left metric and a right metric (S1603 and S1604), and registers the information of an axis set as the combination of the left metric and the right metric to the axis set management table 261 (S1605).

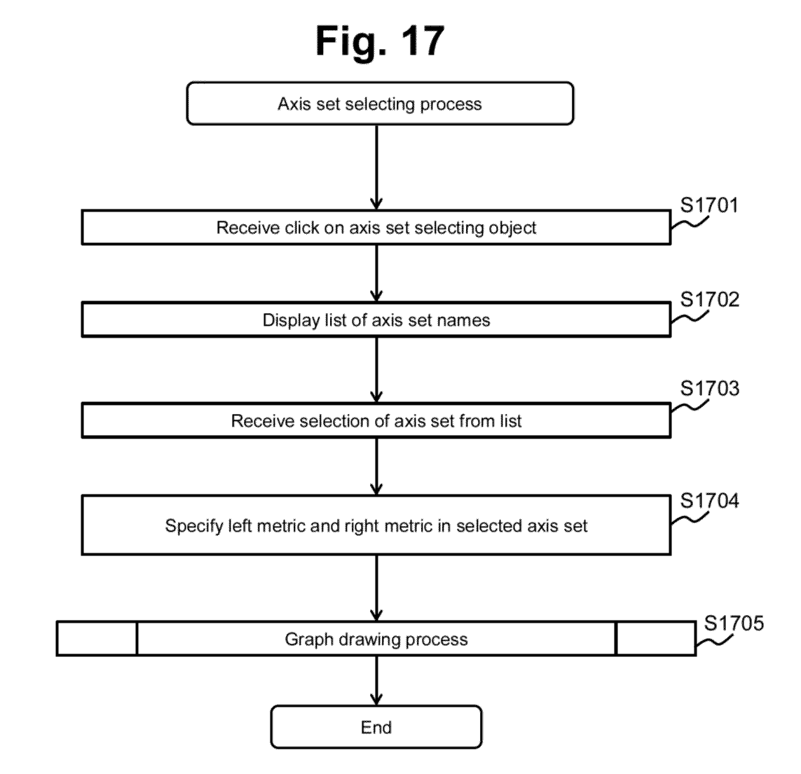

FIG. 17 shows a flow of an axis set selecting process.

The graph management program 252 receives a click on a pull⁻down button of the axis set selecting object 711 (see FIG. 7) (S1701), and displays a list of axis set names 502 specified from the axis set management table 261 (S1702). The graph management program 252 receives selection of an axis set from the list (clicking while a mouse cursor is placed over an axis set name desired by a user) (S1703), and specifies the left metric and the right metric in the selected axis set from the axis set management table 261 (S1704) and performs a graph drawing process (S1705).

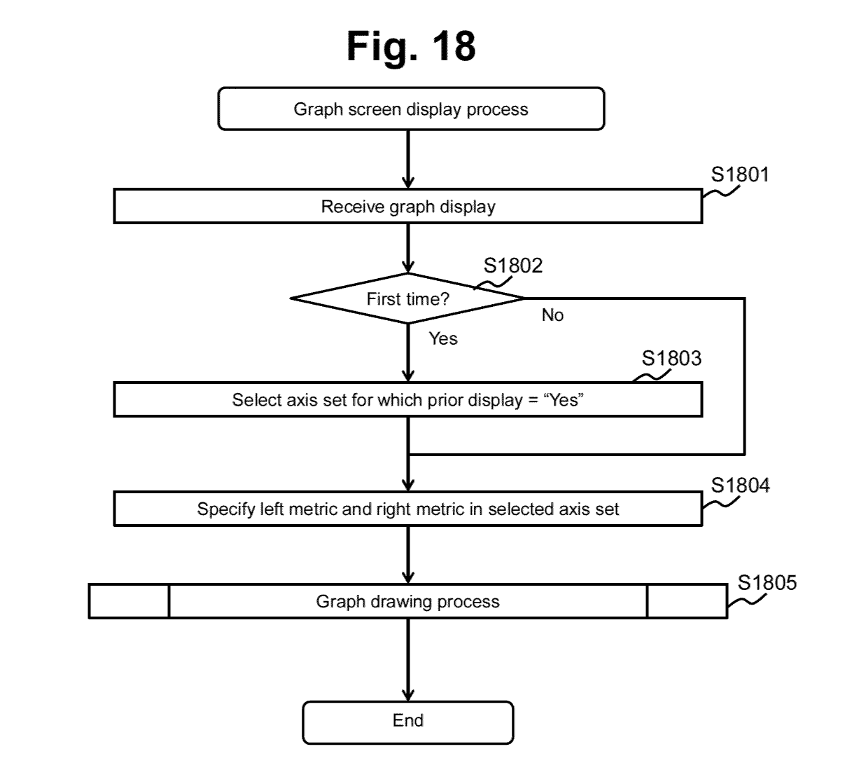

FIG. 18 shows a flow of a graph screen display process.

The graph management program 252 receives a display operation of a graph screen (S1801).

In case of the first graph display (S1802: Yes), the graph management program 252 selects an axis set for which the prior display 505 is “Yes” (S1803). In case of a graph re-display (S1802: No), the axis set may be in an already selected state, for example, the axis set may be an axis set of a graph displayed immediately before. The ID of the axis set of the graph that was displayed immediately before, is stored in e.g., the main storage memory. If the ID of the axis set of the graph that was displayed immediately before, is not stored in the main storage memory, it would be the first graph display. If the ID of such an axis set is stored in the main storage memory, it would be a graph re-display.

The graph management program 252 specifies the left metric and the right metric configuring the selected axis set (S1804), and performs a graph drawing process (S1805).

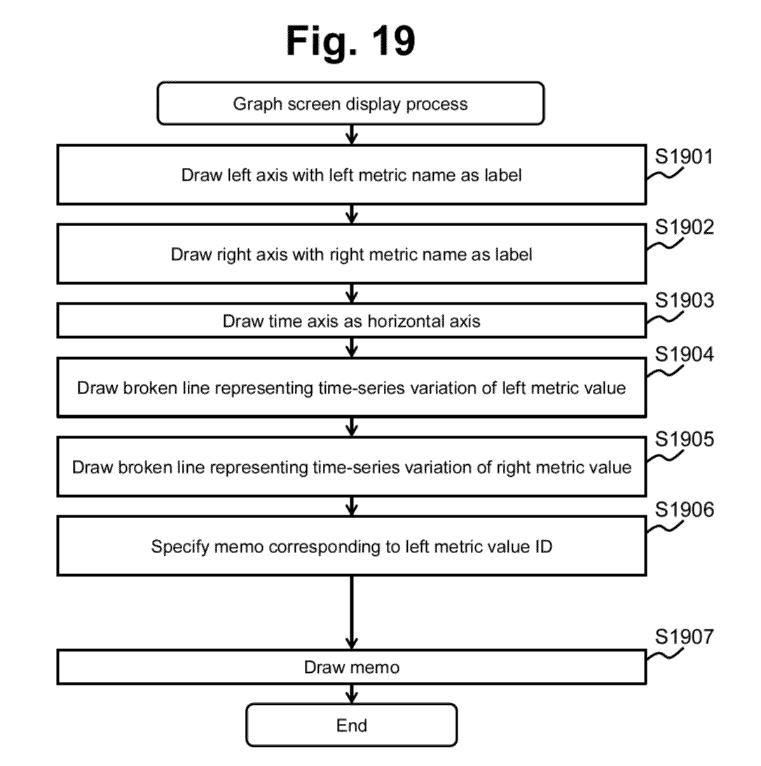

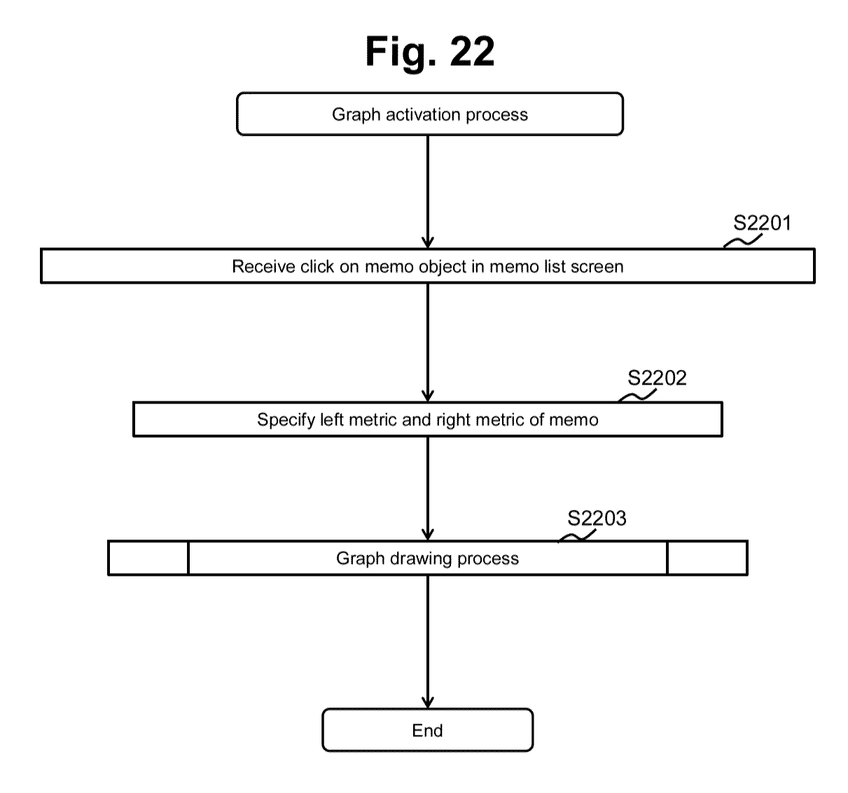

FIG. 19 shows a flow of the graph drawing process. This process is S1705 in FIG. 17, S1805 in FIGS. 18, and S2203 in FIG. 22 which will be described later.

The graph management program 252 draws the left axis (vertical axis) with the name of the left metric in the selected axis set as a label (S1901), draws a right axis (vertical axis) with the name of the right metric in the selected axis set as a label (S1902), and draws the time axis as the horizontal axis (lateral axis) (S1903).

The graph management program 252 specifies left metric values corresponding to the ID of the left metric (for example, left metric values corresponding to time points within the display target time point range, in particular)_from the metric management table 259, and draws a graph object (such as a broken line) that represents the time-series variation of the left metric value at the plot area (S1904). The graph management program 252 specifies right metric values corresponding to the ID of the right metric (for example, right metric values corresponding to time points within the display target time point range, in particular) from the metric management table 259, and draws a graph object (such as a broken line) that represents the time-series variation of the right metric value at the plot area (S1905).

The graph management program 252 specifies a memo of memo coordinates including the left metric value and the time point from the memo management table 260, and draws the memo at the memo coordinates in the graph (S1906).

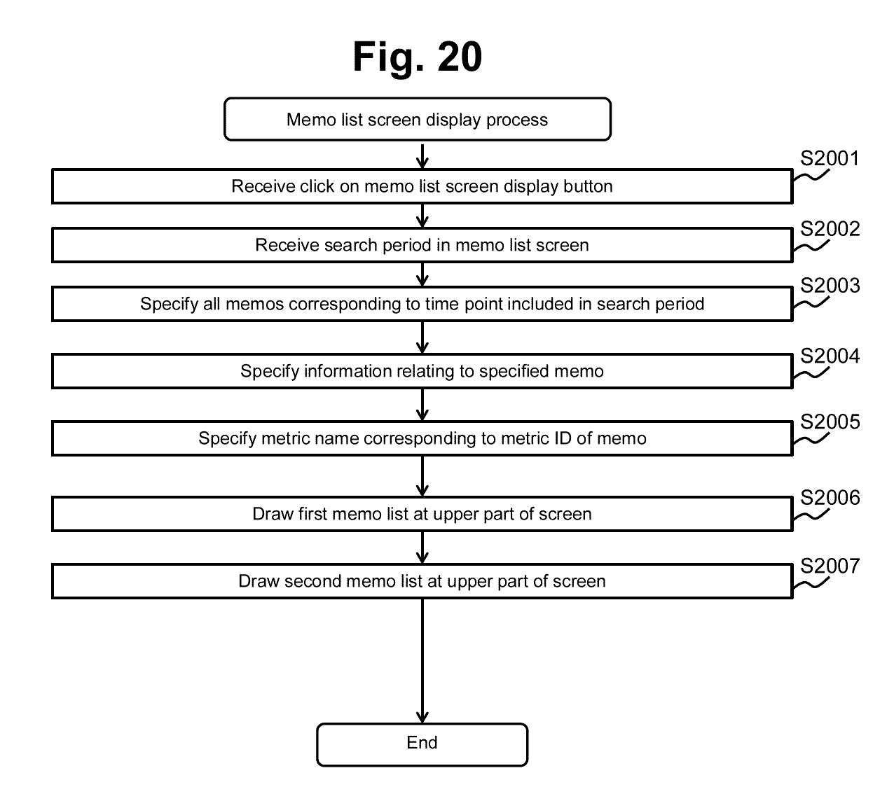

FIG. 20 shows a flow of a memo list screen display process.

The memo management program 253 receives the operation of a memo list screen display (S2001), and receives designation of a search period (S2002). The memo management program 253 specifies a memo of memo coordinates including a time point included in the search period, from the memo management table 260 (S2003), specifies the metric ID, memo text, memo title, and time point of the memo (S2004), and specifies the metric name corresponding to the metric ID (S2005). The memo management program 253 draws the first memo list, which represents, in a table form, the specified memo text, memo title, time point, and metric name, at the upper part of the memo list screen (S2006), and draws the second memo list with a number line having the beginning and end of the search period at both ends, at the lower part of the memo list screen (S2007). In S2007, for example, the memo management program 253 draws an icon representing the memo at a position on the number line, the position corresponding to the time point in the memo coordinates of the memo specified in S2003.

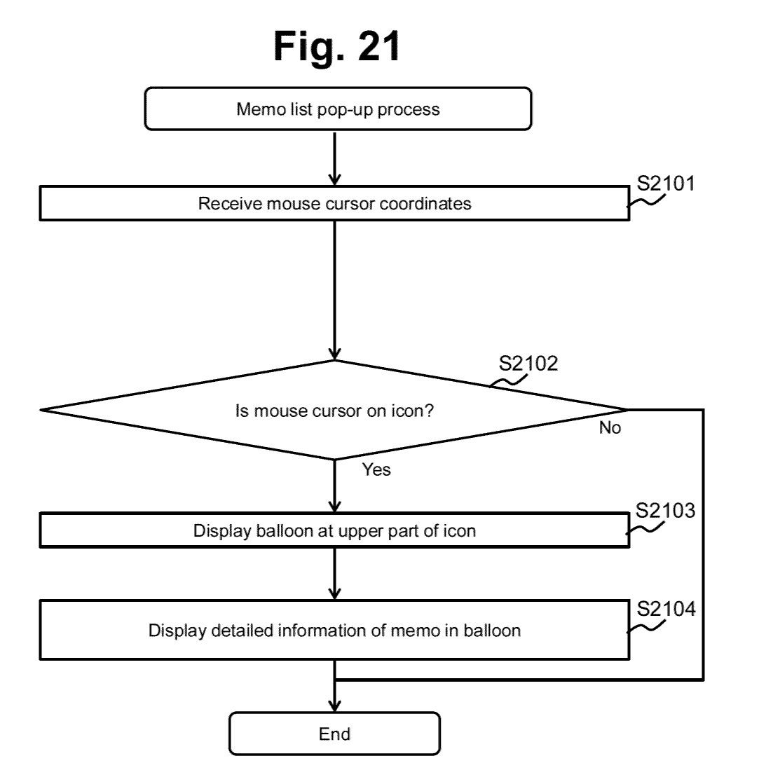

FIG. 21 shows a flow of a memo list pop⁻up process.

The memo management program 253 receives the movement of a mouse cursor (S2101), and if the mouse cursor is placed over an icon in the second memo list (S2102: Yes), the memo management program 253 displays a balloon corresponding to the icon (S2103). The memo management program 253 displays the detailed information (information including the time point, the left metric name, the right metric name, and the memo text) of the memo corresponding to the icon where the mouse cursor is placed over, in the balloon.

FIG. 22 shows a flow of a graph activation process.

The memo management program 253 receives a double click (or a click) on a memo object in the memo list screen (a record in the first memo list or an icon in the second memo list) (S2201). The memo management program 253 specifies the left metric and the right metric for the memo corresponding to the double-clicked (or clicked) memo object (S2202), and instructs the graph management program 252 to activate a graph, thereby performing the graph drawing process (S2203).

Although one embodiment is explained above, it is needless to say that the present invention is not limited to this embodiment, and numerous modification can be made without departing from the gist thereof.

For example, the storage device 222 of the computer for display 102 may store the programs 252 and 253 as well as tables 259 to 261, and drawing of a graph screen, management of a memo, etc. may be performed by the computer for display (client computer) 102, instead of the management server 101. Namely, the computer for display 102 may draw and display, etc. a graph screen by using the management server 101 as an external storage apparatus. In this case, the computer for display 102 can be considered as the management system.

Also, to the memo management table 260, other information, such as the types and IDs of the monitoring target apparatus 104 having a monitoring target, may be registered per memo. Accordingly, it is expected that memos can be read per monitoring target apparatus unit.

Moreover, the present invention is not limited to the analysis of time-series variation of metric value of a monitoring target, and is applicable to the analysis of time-series variation of a value, in accordance with a standpoint, other than metrics, for a target other than a monitoring target. Furthermore, the graph is applicable to a graph in a coordinate system other than the orthogonal coordinate system. Additionally, the graph is not limited to line graphs and may be bar graphs, etc. Also, when the graph is a graph in the orthogonal coordinate system, the first axis may be the vertical axis, the second axis may be the top horizontal axis and the third axis may be the bottom horizontal axis (or the second axis is the bottom horizontal axis and the third axis is the top horizontal axis).

### REFERENCE SIGNS LIST

101: Management server, 102; Computer for display, 104: Monitoring target apparatus

1. A management system comprising:
a storage device configured to store time-series data relating to a target;
an I/O (Input/Output) interface device configured to receive a user operation which is an operation by a user, and output information to be displayed; and
a processor coupled to the storage device and the I/O interface device, and configured to receive the user operation through the I/O interface device and display information through the I/O interface device,
wherein the time-series data includes a value group corresponding to a first standpoint,
wherein the value group is a plurality of values that correspond to a plurality of time points respectively,
wherein the processor is configured to display a graph that has a first axis corresponding to a time and a second axis corresponding to the first standpoint, and represents a time-series variation of a value corresponding to the first standpoint,
wherein the processor is configured to display an electronic tag at designated coordinates which are coordinates designated by a user, in the graph,
wherein the processor is configured to display characters input by the user in the displayed electronic tag,
wherein the processor is configured to store a tag information unit with which a value which is one of the elements of the designated coordinates, a time point which is one of the elements of the designated coordinates, and the characters input to the electronic tag are associated, in the storage device,
wherein the processor is configured to re-display the graph, and
wherein, in the graph that is re-displayed, provided is the electronic tag at coordinates including the value and the time point associated with the tag information unit.

2. The management system according to claim 1,
wherein the storage device is configured to store a plurality of tag information units that correspond to a plurality of electronic tags respectively,
wherein the processor is configured to display a list of a plurality of tag objects that correspond to the plurality of electronic tags respectively, and
wherein the graph, that is re-displayed, is a graph displayed by selecting a tag object by the user from the list.

3. The management system according to claim 2,
wherein the time-series data is a plurality of value groups that correspond to a plurality of standpoints respectively,
wherein, for each tag information unit, identification information of a standpoint, regarding a value corresponding to an electronic tag corresponding to the tag information unit, is associated, and
wherein, on the graph that is re-displayed, provided is an electronic tag corresponding to the value of the first standpoint, among the plurality of electronic tags that correspond respectively to the plurality of tag information units stored in the storage device.

4. The management system according to claim 3,
wherein the processor is configured to display, when a tag object corresponding to an electronic tag corresponding to values of a second standpoint is selected from the list by the user, a graph that has the first axis corresponding to a time and the second axis corresponding to the second standpoint and represents time-series variation of a group corresponding to the second standpoint.

5. The management system according to claim 2,
wherein the list includes a number line with a time point as a number and the plurality of tag objects that are arranged in time series along the number line,
wherein each tag object is an object representing an electronic tag corresponding to the tag object, and exists at a position that matches a time point corresponding to the electronic tag corresponding to the tag object, and
wherein the processor is configured to display at least a portion of information that is associated with a tag information unit corresponding to an electronic tag corresponding to at least one tag object among the plurality of tag objects.

6. The management system according to claim 5,
wherein the time-series data is two or more value groups that correspond to two or more different targets and two or more different standpoints, and
wherein the plurality of electronic tags include two or more electronic tags that correspond to two or more different targets and two or more different standpoints.

7. The management system according to claim 1,
wherein the graph has a third axis that is parallel to the second axis and corresponds to the second standpoint,
wherein coordinates regarding the electronic tag include two values that are a value corresponding to a standpoint corresponding to the second axis and a value corresponding to a standpoint corresponding to the third axis, and
wherein each of a plurality of tag information units respectively corresponding to a plurality of electronic tags, is associated with each item of identification information on the two standpoints that correspond respectively to the two values corresponding to the electronic tag corresponding to the tag information unit.

8. The management system according to claim 7,
wherein, in the graph that is re-displayed, provided is an electronic tag at least corresponding to values of a standpoint that is prioritized between the first and second standpoints, among the plurality of electronic tags.

9. The management system according to claim 8,
wherein the processor, regarding the graph that is re-displayed, is configured to replace priorities of the first and second standpoints with each other to display, instead of the electronic tag displayed in the re-displayed graph, an electronic tag that at least corresponds to a value of the standpoint, which has become to be prioritized, on the graph.

10. The management system according to claim 8,
wherein the prioritized standpoint between the first and second standpoints is a standpoint that corresponds to an axis that is prioritized between the second and third axes.

11. The management system according to claim 1,
wherein the graph has a third axis that is parallel to the second axis,
wherein the processor is configured to receive a configuration of an axis set which is a set of a standpoint to be corresponded to the second axis and a standpoint to be corresponded to the third axis, from the user, and store information relating to the axis set in the storage device, and
wherein the second axis and the third axis of the graph are a graph in accordance with the axis set.

12. The management system according to claim 11,
wherein the storage device is configured to store information relating to a plurality of axis sets, and
wherein the processor, in a state where the graph is displayed, is configured to receive selection of any one of the plurality of axis sets from the user, and display, instead of or in addition to the graph, a graph in accordance with an axis set that is selected by the user.

13. A computer program causing a computer to execute the following steps of:
displaying a graph that has a first axis corresponding to a time and a second axis corresponding to a first standpoint and represents a time-series variation of value corresponding to the first standpoint, on the basis of a value group that is a plurality of values included in time-series data relating to a target, corresponding to the first standpoint, and corresponding respectively to a plurality of time points;
displaying an electronic tag at designated coordinates which are coordinates designated by a user, in the graph;
displaying characters input by the user in the displayed electronic tag;
storing a tag information unit with which a value which is one of the elements of the designated coordinates, a time point which is one of the elements of the designated coordinates, and the characters input to the electronic tag are associated, in a storage device; and
re-displaying the graph, wherein, in the graph that is re-displayed, provided is the electronic tag at coordinates including a value and a time point associated with the tag information unit.

14. A computer system comprising:
a target apparatus which is an apparatus that is a target or includes a target; and
a management system coupled to the target apparatus,
wherein the management system includes a storage device configured to store time-series data relating to the target,
wherein the time-series data includes a value group corresponding to a first standpoint,
wherein the value group is a plurality of values that correspond to a plurality of time points respectively,
wherein the management system is configured to display a graph that has a first axis corresponding to a time and a second axis corresponding to the first standpoint, and represents a time-series variation of a value corresponding to the first standpoint,
wherein the management system is configured to display an electronic tag at designated coordinates which are coordinates designated by a user, in the graph,
wherein the management system is configured to display characters input by the user in the displayed electronic tag,
wherein the management system is configured to store a tag information unit with which a value which is one of the elements of the designated coordinates, a time point which is one of the elements of the designated coordinates, and the characters input to the electronic tag are associated, in the storage device,
wherein the management system is configured to re-display the graph, and
wherein, in the graph that is re-displayed, provided is the electronic tag at coordinates including the value and the time point associated with the tag information unit.
